(19) United States
(12) Patent Application Publication
(10) Pub. No.: US 2026/0200651 A1
(43) Pub. Date: Jul. 16, 2026

(54) BIODEGRADABLE AND NON-FIBROUS FILMS AND METHODS OF FORMING THE FILMS

(71) Applicant: Solstice Advanced Materials US, Inc., Morris Plains, NJ (US)

(72) Inventors: Srinivas Cherukupalli, Hyderabad (IN); Himanshu Pathak, Mumbai (IN)

(73) Assignee: Solstice Advanced Materials US, Inc., Morris Plains, NJ (US)

(21) Appl. No.: 19/434,368

(22) Filed: Dec. 29, 2025

Related U.S. Application Data
(60) Provisional application No. 63/745,378, filed on Jan. 15, 2025.

(51) Int. Cl. B65D 65/46; B65D 81/24; C08J 5/18; C08L 3/00; C08L 67/02

(52) U.S. Cl. CPC B65D 65/466; C08J 5/18; C08L 3/00; C08L 67/02; B65D 81/24; B65D 2565/388

(57) ABSTRACT

Biodegradable and non-fibrous films and methods of forming the films are provided herein. In an embodiment, a biodegradable and non-fibrous film comprises a thermoplastic polysaccharide and a biodegradable polyester. The film has a thickness of from about 15 μm to about 250 μm. When the film has a thickness of 50 μm, the film has a water vapor transmission rate (WVTR) of from about 50 grams per square meter per day to about 2500 grams per square meter per day, as measured in accordance with ASTM E96-22 at a temperature of 38° C., a relative humidity of 90%, an airflow velocity of 0.3 m/s, and a barometric pressure of 941.2 mbar. In an embodiment, a method of forming the biodegradable and non-fibrous film comprises blending a thermoplastic polysaccharide and a biodegradable polyester to form an intermediate composition, and gel extruding the intermediate composition to form the film.

### CROSS REFERENCE TO RELATED APPLICATION

This application claims the benefit of U.S. Provisional Application No. 63/745,378 filed Jan. 15, 2025.

### TECHNICAL FIELD

The present disclosure generally relates to biodegradable and non-fibrous films. The present disclosure more particularly relates to biodegradable and non-fibrous films that are suitable for use in packaging of active materials.

### BACKGROUND

Packaging of active materials is necessary for various applications, including fumigant packets, desiccant packets, fragrance release applications, pharmaceutical and medical packaging, and oxygen or ethylene scavenging. Active materials must be packaged using packaging materials that allow the active material to permeate through the packaging material or that allow ambient air to permeate into the packaging material. Conventional packages for active materials are formed from non-woven porous materials (e.g. paper or Tyvek® material). However, there are problems with these existing packages. Non-woven porous materials may shed particles due to their fibrous nature. Shedding of particles is undesirable in applications such as medical packaging, where particles can cause contamination. Further, layers of non-woven porous materials generally cannot be heat sealed to each other, so an additional layer having a different composition must often be laminated to the material in order to heat seal the packaging. Lamination causes process bottlenecks and inefficiencies, and the packaging may not be effectively sealed, leading to risks such as the active material leaking out of the packaging.

Possible alternatives to non-woven porous materials for use in active packaging are woven porous materials (e.g. woven fabrics). However, woven porous materials generally have a higher permeation rate than non-woven porous materials, allowing the active material to permeate the packaging too quickly, so the active material does not last as long and may not be effective for its intended purpose. Woven porous materials may also have many of the same problems as non-woven porous materials, such as particle shedding and difficulty with sealing.

Other possible alternatives to non-woven porous materials for use in active packaging are non-porous materials such as non-fibrous polymeric materials (i.e. plastic films or multilayer films). Consolidated non-porous, non-fibrous materials do not readily shed particles. Further, layers of non-fibrous materials can often be heat sealed to each other, eliminating the need for lamination of an additional layer having a different composition in order to seal the packaging. However, customary plastics used in active packaging may also have drawbacks. Many plastics have a much lower permeation rate than porous non-woven materials. Low permeability may be desirable in other packaging applications such as food packaging where the goal is to minimize permeation of water or other materials through the packaging. However, in active material packaging where the active material (or another material such as air or water vapor) is intended to permeate through the packaging, the lower permeation rate of plastics may lead to the active material or other material permeating through the packaging too slowly or not at all, making the product containing the active material ineffective. Further, after they are discarded, many plastic materials end up in landfills or in the ocean, where they remain for an extended period of time or break down into microplastics. Environmental preservation initiatives have increased demand for materials that are biodegradable and/or compostable.

Accordingly, it is desirable to provide biodegradable and non-fibrous polymeric films having a permeation rate that is suitable for use in packaging of active materials that are intended to permeate the films. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Biodegradable and non-fibrous films and methods of forming the films are provided herein. In an embodiment, a biodegradable and non-fibrous film comprises a thermoplastic polysaccharide and a biodegradable polyester. The film has a thickness of from about 15 μm to about 250 μm. When the film has a thickness of 50 μm, the film has a water vapor transmission rate (WVTR) of from about 50 grams per square meter per day to about 2500 grams per square meter per day, as measured in accordance with ASTM E96-22 at a temperature of 38° C., a relative humidity of 90%, an airflow velocity of 0.3 m/s, and a barometric pressure of 941.2 mbar.

In another embodiment, a method of forming a biodegradable and non-fibrous film comprises blending a thermoplastic polysaccharide and a biodegradable polyester to form an intermediate composition, and gel extruding the intermediate composition to form the film.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Biodegradable and non-fibrous films, and methods of forming the biodegradable and non-fibrous films, are provided herein. The non-fibrous nature of the films makes them suitable for use in active material packaging because the films exhibit minimal shedding of particles, and layers of the films can be heat sealed to each other, eliminating the need for lamination of an additional layer different from the film thereto. The films comprise a thermoplastic polysaccharide and a biodegradable polyester, materials which contribute to the biodegradability of the films. It has been found that, when the film has a thickness of from about 15 μm to about 250 μm, films can be produced having a water vapor transmission rate (WVTR) of from about 50 grams per square meter per day to about 2500 grams per square meter per day, as measured in accordance with ASTM E96-22 at a temperature of 38° C., a relative humidity of 90%, an airflow velocity of 0.3 m/s, and a barometric pressure of 941.2 mbar. The recited WVTR, which represents the permeability of the film, has been found to be suitable for films used in packaging active materials for purposes of allowing permeation of the active material through the film, or for allowing another material such as air or water vapor to permeate the film and contact the active material.

Unless specifically stated or obvious from context, as used herein, the term “about” is understood as within a range of normal tolerance in the art measured using standard measurement devices for a given measurement, for example within 2 standard deviations of the mean for a particular measurement device. For example, “about” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, a material that is “biodegradable” refers to a material that is capable of undergoing decomposition into carbon dioxide, methane, water, inorganic compounds, or biomass, through the enzymatic action of microorganisms, under any conditions and over any period of time. A biodegradable material may or may not be “compostable” as defined by the compostability test method of ASTM standard D6400. A biodegradable material may or may not be recyclable.

As used herein, a material that is “compostable” refers to a material that is capable of undergoing decomposition into carbon dioxide, methane, water, inorganic compounds, or biomass, through the enzymatic action of microorganisms, over a minimum of 90 days in an aerobic and controlled composting environment. The conditions required for the aerobic and controlled composting environment are described in the US industrial composting standards ASTM D6400 and ASTM D6868. Some compostable materials are capable of undergoing the described decomposition under less stringent conditions than required by ASTM D6400. For example, if a material is compostable under marine conditions (as defined in ASTM D7081), then more than 90% of the material degrades in less than six months, and more than 90% of the material disintegrates (i.e. breaks down into pieces measured less than 2 mm) in less than 84 days, in an environment having a temperature of from 20° C. to 25° C. As another example, if a material is compostable under soil conditions (as defined in ASTM D5929), then more than 90% of the material degrades in less than 24 months in an environment having a temperature of from 20° C. to 25° C.

As used herein, a material that is “non-porous” refers to a material that is substantially free of pores, holes, or spaces in its internal structure. Examples of non-porous materials may include plastics, glass, and metals. Of particular relevance to this disclosure are non-porous polymeric materials.

As used herein, a material that is “non-fibrous” refers to a material that is free from fibers in its structure. As used herein, “fibers” refers to long, thread-like structures that may be organized (e.g. woven, bonded, or entangled) together to form a material structure. Non-fibrous materials may have a crystalline structure or an amorphous structure.

As used herein, a “thermoplastic” material refers to a material that reversibly softens and becomes moldable upon heating, and reversibly hardens upon cooling. A “thermoplastic polysaccharide” refers to a polysaccharide whose structure has been modified to impart thermoplastic properties on the polysaccharide. The polysaccharide may be modified using heat, shear forces, and/or the addition of materials such as plasticizers.

As used herein, “water vapor transmission rate” or “WVTR” refers to the rate at which water vapor moves through a material, expressed as the amount of water vapor that passes through a unit area of the material per unit time under specified temperature and humidity conditions. Unless otherwise specified, all values for WVTR in this disclosure are expressed in units of grams of water per square meter per day, as measured in accordance with the standard methods of ASTM E96-22 (version released October 2022) at a temperature of 38° C., a relative humidity of 90%, an airflow velocity of 0.3 m/s, and a barometric pressure of 941.2 mbar.

As used herein, the “peak melting point” of a polymer refers to the temperature at which a differential scanning calorimeter (DSC) trace peaks for the polymer, as measured with a scan rate of 10 C/min.

As used herein, the “melt flow index” or “MFI” of a polymer represents the flowability of a polymer. A higher melt flow index indicates that the polymer is more flowable (i.e. flows more quickly) under the specified conditions. Unless otherwise specified, all values for MFI in this disclosure are expressed in units of g/10 min and are measured in accordance with the standard methods of ASTM D1238-23 (version released February 2023) at a temperature of 190° C. and with a load of 2.16 kg. It should be noted that, for any given polymer, the MFI may vary by, for example, about +/−2 g/10 min due to variability in weight average molecular weight of the polymer.

As used herein, “active material” refers to any material used in an application in which the material is retained between opposing layers of a film (i.e. disposed in a void formed by the opposing layers of the film) and diffuses through the film over a period of time, or absorbs another material that diffuses through the film and into the void over a period of time, to serve an intended purpose. The purpose may be, for example, to kill pests, to absorb moisture, to absorb oxygen or ethylene, or to impart a fragrance.

As set forth above, the films described herein comprise a thermoplastic polysaccharide. The thermoplastic polysaccharides as contemplated herein provide maximized biodegradability of the film. Thermoplastic polysaccharides are biodegradable and are generally also compostable under both natural and industrial conditions, allowing them to be broken down by enzymes and/or microorganisms when they are incorporated into films. The thermoplastic polysaccharide also affects the permeability, such as the water vapor transmission rate, of the film. Thermoplastic polysaccharides generally have higher permeability than other polymers, at least partially because of polar hydroxyl functional groups present in thermoplastic polysaccharides, which may contribute to absorption by and/or release of an active material through the film via diffusion.

The film may contain only one thermoplastic polysaccharide, or alternatively, the film may contain more than one thermoplastic polysaccharide. In embodiments, the thermoplastic polysaccharide is formed from a polysaccharide selected from a starch, carrageenan, cellulose, viscose, glycogen, chitin, hemicellulose, or combinations thereof. In embodiments, the thermoplastic polysaccharide is formed from a starch selected from corn starch, wheat starch, potato starch, rice starch, cassava starch, tapioca starch, arrowroot starch, or combinations thereof. In embodiments, the thermoplastic polysaccharide is present in an amount of from about 20 wt % to about 70 wt %, alternatively from about 30 wt % to about 60 wt %, alternatively from about 40 wt % to about 50 wt %, based on a total weight of the film. Inclusion of the thermoplastic polysaccharide in the film in the recited amounts may help the film achieve a WVTR in a desired range, as described in more detail below.

As also set forth above, the films described herein comprise a biodegradable polyester. The biodegradable polyester as contemplated herein also contributes to maximized biodegradability of the film. While biodegradable polyesters may or may not be compostable, their biodegradability properties allow them to be more easily broken down by enzymes and microorganisms when they are incorporated into the film. The biodegradable polyester also exhibits improved thermal and shear resistance properties as compared to the properties of thermoplastic polysaccharides, so the presence of the biodegradable polyester in the film contributes to processability, allowing commercial manufacturing practices to be followed. The biodegradable polyester also affects the permeability, such as the water vapor transmission rate, of the film. Biodegradable polyesters generally have lower permeability than materials that are conventionally used in active material packaging, and thermoplastic polysaccharides generally have higher permeability than materials that are conventionally used in active material packaging. Thus, combining the thermoplastic polysaccharide and the biodegradable polyester in the film enables the permeability of the resulting material to be controlled within a desirable range, particularly for active material packaging. The thermoplastic polysaccharide and the biodegradable polyester also give the film its non-fibrous nature, which may contribute to uniformity in thickness, structure, and permeability of the film. The non-fibrous nature of the film may also allow the film to be more effectively heat sealed.

The film may contain only one biodegradable polyester, or alternatively, the film may contain more than one biodegradable polyester. In embodiments, the biodegradable polyester is selected from polylactic acid, polybutylene adipate terephthalate, polycaprolactone, polyhydroxybutyrate, poly(3-hydroxybutyrate-co-3-hydroxyhexanoate, poly(3-hydroxybutyrate-co-3-hydroxyvalerate), polybutylene succinate, polysulfone, or combinations thereof. In embodiments, the biodegradable polyester is selected from polylactic acid, polybutylene adipate terephthalate, or combinations thereof. In embodiments, the biodegradable polyester is present in an amount of from about 20 wt % to about 80 wt %, alternatively from about 30 wt % to about 70 wt %, based on a total weight of the film.

In embodiments, the thermoplastic polysaccharide and the biodegradable polyester are present in the film in a combined amount of at least 50 wt %, alternatively from about 50 wt % to less than 100 wt %, alternatively from about 80 wt % to about 95 wt %, based on a total weight of the film. In embodiments, the thermoplastic polysaccharide is thermoplastic starch formed from corn starch, and the biodegradable polyester is a combination of polylactic acid (PLA) and polybutylene adipate terephthalate (PBAT).

In embodiments, the biodegradable polyester is modified with functional groups that provide plasticizing performance. In embodiments, the biodegradable polyester may comprise the reaction product of a polyester and a plasticizer, which forms the modified biodegradable polyester having residues from the plasticizer bonded therein (i.e. the plasticizer is incorporated into the biodegradable polyester through covalent bonding to form functional groups in the modified polyester). The modified biodegradable polyester having the residues from the plasticizer exhibits modified flow properties, and the plasticizer may thus be inhibited from leaching during film formation and/or migrating out of the film in its final application.

In other embodiments, the film further comprises a plasticizer as a distinct component in the film that is not covalently bonded within the polyester. As used herein, “plasticizer” refers to a substance that promotes plasticity and flexibility of a polymer, and that is different from the thermoplastic polysaccharide and the biodegradable polyester (i.e. the plasticizer is not a biodegradable polyester or a thermoplastic polysaccharide). The plasticizer may increase the MFI and thus increase flowability at lower temperatures during film formation, which may also improve the biodegradability of the resulting film. The film may contain only one plasticizer, or alternatively, the film may contain more than one plasticizer. In embodiments, intermolecular forces form a physical or ionic bond between the plasticizer and the thermoplastic polysaccharide and/or the biodegradable polyester (e.g. van der Waals forces or hydrogen bonding).

In embodiments, the plasticizer has a molecular weight of at least about 5000 g/mol, alternatively from about 5000 g/mol to about 15000 g/mol, alternatively from about 5000 g/mol to about 8000 g/mol, alternatively at least about 8000 g/mol, which contributes to minimized migration of the plasticizer out of the film. A molecular weight in the recited range may be advantageous because it is low enough to contribute to flowability during film formation but high enough to contribute to thermal stability of the film.

In embodiments, the plasticizer may be a fatty acid, a long-chain alcohol, or a polyol or polymerization product thereof. A polyol, as defined herein, is an organic molecule having more than one hydroxyl group. For example, the plasticizer may be polyethylene glycol, propylene glycol, glycerol, or combinations thereof. In other embodiments, the plasticizer may be an oil comprising a hydrocarbon chain. The plasticizer may exhibit antioxidant properties at typical environmental temperatures of from −20° C. to 70° C. The plasticizer may be present in an amount of from about 1 wt % to about 15 wt %, alternatively from about 1 wt % to about 10 wt %, alternatively from about 1.5 wt % to about 10 wt %, alternatively from about 1.5 wt % to about 8 wt %, alternatively from about 2 wt % to about 6 wt %, alternatively from about 2 wt % to about 4 wt %, based on a total weight of the film.

In embodiments, the film further comprises a polymer-degrading enzyme. The polymer-degrading enzyme contributes to maximized biodegradability of the film. As used herein, a “polymer-degrading enzyme” refers to any enzyme that tends to break down a polymeric material over time. Polymer-degrading enzymes act to break down polymers under certain conditions, expediting the biodegradation process (and thus improving biodegradability). The film may contain only one polymer-degrading enzyme, or alternatively, the film may contain more than one polymer-degrading enzyme. The type of polymer-degrading enzyme(s) present in the film may be chosen based on the type of thermoplastic polysaccharide(s) and/or biodegradable polyester(s) present in the film. In embodiments, the enzyme is encapsulated, either fully or partially, within a carrier material. The carrier material may be a polymer such as, for example, chitosan, alginate, polyethylene glycol, or polyvinyl alcohol. In embodiments, the carrier material may be a metal-organic framework. With the enzyme encapsulated in the carrier material, degradation of the enzyme is inhibited and the enzyme is allowed to remain inactive until it is exposed to certain composting conditions.

In embodiments, the polymer-degrading enzyme is selected from an oxidoreductase, a transferase, a hydrolase, a lyase, an isomerase, a ligase, or combinations thereof. In embodiments, the polymer-degrading enzyme is a microbial hydrolase that catalyzes hydrolysis reactions in the presence of water (e.g. hydrolysis of the ester bond in the biodegradable polyester). The microbial hydrolase may be selected from a lipase, an esterase, and/or combinations thereof. In embodiments, the polymer-degrading enzyme may originate from Acidovorax delafieldii, Amycolatopsis orientalis ssp. orientalis, Amycolatopsis sp. K104-1, Aspergillus oryzae, Brevundimonas sp. MRL-AN1, Cryptococcus sp. S-2, Cryptococcus flavus GB-1, Cryptococcus magnus, Fusarium sp. FS1301, Paenibacilus amylolyticus TB-13, Paraphoma-related fungus B47-9, Psudozyma antarctica JCM 10317, Ralstonia sp. MRL-TL, Thielavia terretris CAU709, and/or combinations thereof. In embodiments, the initial activity of the enzyme may be from about 1 KLU/g to about 25 KLU/g, alternatively from about 1 KLU/g to about 10 KLU/g, alternatively from about 1 KLU/g to about 5 KLU/g, alternatively from about 5 KLU/g to about 10 KLU/g. In embodiments, the enzyme may be present in an amount of from about 0.01 wt % to about 5 wt %, alternatively from about 0.01 wt % to about 1 wt. %, alternatively from about 0.1 wt % to about 1 wt %, based on a total weight of the film. The amount of the enzyme may be determined based on the initial activity of the enzyme. For example, in an embodiment, from about 0.1 wt % to about 0.5 wt % of the enzyme is included in the film, based on a total weight of the film, per KLU/g of initial activity of the enzyme.

In embodiments, the biodegradable and non-fibrous film is further characterized as non-porous. The non-porous nature of the film contributes to minimized particle shedding, uniformity of thickness and permeability of the film, and the ability of the film to be heat sealed without laminating an additional layer to the film. In other embodiments, the biodegradable and non-fibrous film is characterized as microporous. As used herein, a “microporous” material comprises pores with diameters in the micron or nanometer range. For example, a microporous material may have pores with diameters of less than 2 nanometers.

In embodiments, the film has a thickness of from about 15 μm to about 250 μm, alternatively from about 20 μm to about 200 μm, alternatively from about 20 μm to about 150 μm. The recited film thickness is high enough to impart desirable strength properties on the film, and low enough that the film can be flexible and easily handled. Further, the combination of the recited film thickness and the inclusion of the thermoplastic polysaccharide and the biodegradable polyester in the film may yield a permeability that is appropriate for using the film in active packaging applications.

In embodiments, the film has a water vapor transmission rate (WVTR) of from about 50 grams per square meter per day to about 2500 grams per square meter per day, alternatively from about 150 grams per square meter per day to about 1000 grams per square meter per day, alternatively from about 200 grams per square meter per day to about 500 grams per square meter per day, alternatively from about 200 grams per square meter per day to about 350 grams per square meter per day, as measured in accordance with ASTM E96-22 at a temperature of 38° C., a relative humidity of 90%, an airflow velocity of 0.3 m/s, and a barometric pressure of 941.2 mbar, for a sample having a thickness of 50 μm. The recited WVTR values represent a film permeability that is high enough to allow active material and/or another material such as air or water vapor to pass through the film for its intended purpose, but low enough to prevent the active material from being used up too quickly.

In embodiments, the WVTR of the film varies by from about 0.1 grams per square meter per day to about 100 grams per square meter per day, alternatively from about 0.1 grams per square meter per day to about 90 grams per square meter per day, across a sample of the film having a surface area of 50 square centimeters, as measured in accordance with ASTM E96-22 at a temperature of 38° C., a relative humidity of 90%, an airflow velocity of 0.3 m/s, and a barometric pressure of 941.2 mbar. The recited variation in WVTR may be related to variation in film thickness. The recited variation in WVTR represents a much smaller variation than is typical of many porous materials that are conventionally used for active packaging. As a result, the films as contemplated herein provide for a more uniform (and thus more consistent and predictable) permeation of active material or other material such as air or water vapor through the film than existing packaging materials. It is thought that the absence of tortuosity in the non-fibrous films contemplated herein contributes to the substantially uniform permeation rate.

In embodiments, a blend of the thermoplastic polysaccharide and the biodegradable polyester has a peak melting point of from about 80° C. to about 180° C., alternatively from about 90° C. to about 170° C., alternatively from about 100° C. to about 160° C., alternatively from about 120° C. to about 140° C. A peak melting point in the recited ranges allows the resulting film to be heat sealed without the need to laminate an additional layer different from the film thereon. Heat sealing the film without laminating an additional layer different from the film thereon allows for the use of fewer resources during manufacturing of the film. In embodiments, the film is a single layer having a uniform composition. As used herein, a “uniform composition” means that the composition of the film is the same throughout the film, with all the components substantially evenly distributed, so that any sample taken from the film would have the same properties. The substantially uniform composition of the film allows for a consistent heat seal, reducing the risk of a faulty seal that may allow active material to leak out of a package formed from the film.

Biodegradable packages are also contemplated herein. The biodegradable packages are formed from the biodegradable and non-fibrous films provided herein. The package may be formed from one continuous piece of the film, or alternatively, the package may be formed from two or more separate pieces of the film. In embodiments, the biodegradable package has an inner surface that defines a void. The void provides space for parts, products, or materials to be stored.

In embodiments, the biodegradable package is free of any additional layer different from the film laminated thereon. In embodiments, the biodegradable package is free of a woven or non-woven porous material. The absence of an additional layer different from the film, such as a layer formed from a woven or non-woven porous material, contributes to manufacturing efficiency, consistency of sealing, and substantial uniformity of permeability of the package.

In embodiments, the biodegradable package further comprises an active material retained by opposing layers of the film (i.e. disposed in the void). In embodiments, the active material is selected from fumigants, desiccants, oxygen or ethylene scavengers, aroma compounds, or combinations thereof. Examples of fumigants include methyl bromide, chloropicrin, 1,3-dichloropropene, ethylene oxide, sulfuryl fluoride, ethylene dibromide, metam sodium, dimethyl disulfide, phosphine, and organophosphate. Examples of desiccants include silica, activated charcoal, calcium sulfate, calcium chloride, and molecular sieves. Examples of oxygen scavengers include ferrous oxide, sodium sulfite, ascorbic acid, erythorbic acid, catechols, diethylhydroxylamine (DEHA), carbohydrazide, and hydroquinone. Examples of ethylene scavengers include potassium permanganate, titanium dioxide, palladium, bentonite, and sillimanite. Examples of aroma compounds include terpenes, aldehydes, ketones, lactones, and esters. The aroma compounds may impart a fragrance of, for example, citrus or vanilla.

In embodiments, the opposing layers of the film are sealed to each other about a perimeter thereof to define a void that is at least partially sealed. In embodiments, the void is completely sealed. The sealed void houses the active material and inhibits the active material from leaking out of the packaging. The package is particularly suited for retaining the active material because of the non-fibrous nature of the package, the above-recited WVTR values of the package, and the uniformity of thickness and permeability.

Methods of forming the biodegradable and nonfibrous films are also contemplated herein. The methods comprise blending a thermoplastic polysaccharide and a biodegradable polyester to form an intermediate composition, and gel extruding the intermediate composition to form a film. As used herein, “intermediate composition” refers to the composition that results from blending, but that has not yet been gel extruded to form the film. The intermediate composition contains the thermoplastic polysaccharide and the biodegradable polyester. The intermediate composition may also contain the plasticizer, the polymer-degrading enzyme, reaction products of the biodegradable polyester and the plasticizer, reaction products of the thermoplastic polysaccharide and the plasticizer, other side reaction products, impurities, other components, and/or combinations thereof.

In the methods contemplated herein, the thermoplastic polysaccharide and the biodegradable polyester are blended to disperse all components throughout the resulting intermediate composition, maximizing the uniformity of the composition and contributing to a desirable peak melting point and WVTR of the film formed from the intermediate composition. In embodiments, the intermediate composition is visibly homogeneous. Additional components may also be blended with the thermoplastic polysaccharide and the biodegradable polyester to form the intermediate composition. In embodiments, the polymer-degrading enzyme and/or the plasticizer are blended with the thermoplastic polysaccharide and the biodegradable polyester during the blending step. Dispersing the plasticizer throughout the intermediate composition increases the melt flow index (MFI) of the intermediate composition, which is beneficial to enable the gel extrusion step, as described below.

In embodiments, the thermoplastic polysaccharide and the biodegradable polyester may be blended through high shear mixing, low shear mixing, kneading, and/or dispersion mixing, to form an intermediate composition. In embodiments, the thermoplastic polysaccharide and the biodegradable polyester may be blended within a twin screw extrusion unit and/or a single screw extrusion unit. In embodiments, the twin screw extrusion unit uses a twin screw extruder having at least 10% kneading elements. The blending technique may be selected based on the properties of the thermoplastic polysaccharide, the biodegradable polyester, and any additional components being blended. In embodiments, blending is carried out in an environment having a temperature of about 25° C. In embodiments, the thermoplastic polysaccharide, biodegradable polyester, and any additional components being blended may reach a temperature of about 60° C. to about 70° C. during blending.

In embodiments, the intermediate composition has a melt flow index of at least about 4 g/10 min, alternatively from about 4 g/10 min to about 6 g/10 min, alternatively at least about 6 g/10 min, alternatively from about 6 g/10 min to about 7 g/10 min, alternatively at least about 7 g/10 min, alternatively from about 7 g/10 min to about 12 g/10 min, alternatively at least about 12 g/10 min, as measured in accordance with ASTM D1238-23 at a temperature of 190° C. and with a load of 2.16 kg. If the plasticizer is present in the intermediate composition, the MFI of the intermediate composition may be higher than the MFI of at least one of the thermoplastic polysaccharide or the biodegradable polyester, due to the change in the flow properties of the polymer as a result of the plasticizer. The increased MFI may lead to excellent flow properties of the intermediate composition. The flow properties of the intermediate composition allow the intermediate composition to be extruded at lower temperatures and at faster speeds than may be possible without use of the plasticizer. The benefits of extrusion at lower temperatures and faster speeds are described below.

The methods provided herein further include gel extruding the intermediate composition to form the film. In “gel extrusion,” material is forced through a nozzle or die under controlled conditions to extrude a continuous profile of the desired shape, where the material is in the form of a gel during the extrusion. As used herein, “gel” refers to a viscoelastic multicomponent system formed by a structure-forming component and an absorbed liquid. A gel exhibits both viscous and elastic characteristics when undergoing deformation. This means that a gel has flow properties characteristic of fluids, while having elastic properties making it incapable of irreversible deformations. As used herein, a “gel” has a melt flow index (MFI) of at least about 4 g/10 min, alternatively at least about 5 g/10 min, alternatively from about 5 g/10 min to about 12 g/10 min, alternatively at least 12 g/10 min, as measured in accordance with ASTM D1238-23 at a temperature of 190° C. with a load of 2.16 kg. In the methods provided herein, the intermediate composition is a gel before and/or during extrusion. In embodiments of the methods provided herein in which the plasticizer is present in the intermediate composition, the plasticizer affects the flow properties of the intermediate composition, facilitating gel extrusion of the intermediate composition.

In gel extrusion, the material being extruded can be pushed through the extruder at a lower temperature than would be possible in a conventional hot melt extrusion due to the unique flow properties of a gel. This allows for extrusion of biodegradable polymers which may be less heat resistant than non-biodegradable polymers traditionally used in polymeric films and that may break down under the heat of a traditional hot melt extrusion process. Further, if enzymes are contained in the intermediate composition, the enzymes are generally sensitive to heat, so extrusion with minimized heating of the material allows for extrusion of the intermediate composition while minimizing degradation of any enzymes that may be present. Minimized degradation of the enzymes during extrusion leads to maximized enzyme activity in the resulting film, yielding maximized compostability of the material. Extrusion at lower temperatures and faster processing times may also reduce the cost of the manufacturing process.

In embodiments, gel extrusion may be conducted using a single-screw extruder, or alternatively a twin screw extruder. In embodiments, the intermediate composition is extruded at a temperature below the peak melting point of a blend of the thermoplastic polysaccharide and the biodegradable polyester. In embodiments, the intermediate composition is extruded at a temperature of the intermediate composition of less than about 180° C., alternatively from about 80° C. to about 180° C., alternatively less than about 165° C., alternatively from about 100° C. to about 165° C.

In embodiments, the intermediate composition is extruded to directly form the film (i.e. the extrudate is the formed film). In other embodiments, the compostable polymeric material (i.e. extrudate) is further formed into the film. For example, the intermediate composition may be extruded to form pellets or granules, and the pellets or granules may then be formed into the film. The pellets or granules may be formed into the film by any known method, for example, by blowing, casting, thermoforming, compression pressing, or milling.

In embodiments, the method further comprises forming the film into the package having the inner surface that defines a void, as described above. In embodiments, the film may be in the form of the package directly after extrusion of the intermediate composition to form the film. In embodiments, the film or other extrudate may be formed into the package by any known method, for example, by blowing, casting, thermoforming, compression pressing, or milling. In embodiments, the film is formed into the package by folding a piece of the film or by positioning two separate pieces of the film opposite each other, and bonding together the resulting opposing layers of the film. The opposing layers of the film may be bonded tougher using heat, pressure, and/or adhesives. In embodiments, the opposing layers of the film are bonded together by heat sealing. Heat sealing involves applying both heat and pressure to the opposing layers of the film. In embodiments, the opposing layers of the film are inserted into a heat sealer having a heated die or sealing bar. The heated die or sealing bar may have a temperature of from about 100° C. to about 200° C., alternatively from about 110° C. to about 190° C., alternatively from about 120° C. to about 170° C. The heated die or sealing bar may be pressed onto the opposing layers of the film with an applied pressure of from about 0.1 MPa to about 0.5 MPa, alternatively from about 0.1 MPa to about 0.3 MPa, for a time period of from about 0.1 seconds to about 5 seconds, alternatively from about 0.1 seconds to about 2 seconds. In other embodiments, the opposing layers of the film are heat sealed using an automatic band sealer. The opposing layers of the film are placed between conveyor belts and carried through a band heater zone at a specified temperature under compression. The sealed layers may be allowed to cool under ambient conditions.

In embodiments, the method further comprises sealing opposing layers of the film to each other about a perimeter thereof to define a sealed void. In embodiments, the sealed void completely encompasses the active material therein. This step creates a packaged active product, such as a fumigant packet or a desiccant packet. In embodiments, after the package having an inner surface that defines a void is formed as describe above, an active material is inserted into the void defined by the package. The active material may be inserted into the void through an opening in the package by any known method. Then, the opening through which the active material was inserted may be sealed, for example by heat sealing as described above. Alternatively, the opposing layers of the film may be completely sealed around the void, for example by heat sealing as described above, and then the active material may be injected into the void. In embodiments, the method is free of laminating any additional layer different from the biodegradable and non-fibrous film to the biodegradable and non-fibrous film.

### EXAMPLES

### Example 1

A biodegradable and non-fibrous film was prepared in accordance with this disclosure. Precipitated silica (500 g) and glycerol (500 g) were blended in a high-speed mixer (Jogindra Engineering JJH-010) for 10 minutes. Thereafter, the blend was added to a kneader containing 1000 g of native corn starch. The kneader was operated for 10 minutes resulting in a thermoplastic starch (TPS) dough. The dough was run through a single screw extruder with die-cutter to produce TPS pellets.

A dry mixture was prepared in a high-speed mixer of the elements shown in Table 1 below.

TABLE 1
Components of Intermediate Composition for Example 1

| Component | Amount (wt %) |
|---|---|
| Thermoplastic Corn Starch (TPS) | 35 |
| Polylactic Acid (PLA) | 5 |
| Polybutylene Adipate Terephthalate (PBAT) | 50 |
| Compatibilizer | 3 |
| Calcium Carbonate | 5 |
| Other Additives | 2 |

The amounts shown in Table 1 are weight percentages based on a total weight of the dry mixture.

The PLA in Table 1 is commercially available from TotalEnergies Corbion Ltd. under the trade name Luminy® LX175.

The PBAT in Table 1 is commercially available from Stavian Chemical under the trade name Kingfa KB100 LF.

The compatibilizer in Table 1 is commercially available from Aadibond Functional Polymers under the trade name Aadibond® 9100.

The high-speed mixer was run for 15 minutes to mix the components of Table 1. After mixing, the melt flow index of the resulting compounded material (i.e. intermediate composition) was 4-7 gm/10 min, as measured in accordance with ASTM D1238-23 at a temperature of 190° C. and with a load of 2.16 kg.

In a twin-screw extruder (Useon™ 20, Nanjing Extrusion) with 20% kneading block elements, L/D of 48/1, and screw diameter of 22 mm, the intermediate composition was fed through a loss in weight hopper. The strand die was maintained at a temperature of 150-160° C. and the compounded material was pelletized under water cooling. Vacuum pull was maintained to reduce the amount of water absorbed into the mixture. The resultant pellets were oven dried at a temperature of 65° C. for 4 hours, until the percentage of water absorbed was less than 0.5%.

The compounded pellets were extruded on a blown film line to make film samples having a thickness of 50-80 microns and a surface area of 50 cm². The WVTR of the film of Example 1 was tested in accordance with ASTM E96-22, with a temperature of 38° C., a relative humidity of 90%, an airflow velocity of 0.3 m/s, and a barometric pressure of 941.2 mbar. The WVTR of the sample was measured approximately every 4-5 hours until the variation between subsequent measurements was less than 5%. The measurements were recorded. The average and standard deviation of the WVTR measurements were calculated to yield a result of 275.95+/−27.01 grams per square meter per day.

For comparison purposes, the WVTR values of polylactic acid (PLA) and polybutylene adipate terephthalate (PBAT) were obtained from the literature. The values for PLA were obtained from “Water Vapour Permeability of Bio-based Polymers” (Duan, Zhouyang, 2013). The values for PBAT were obtained from IOP Conf Ser.: Mater. Sci. Eng. 773 012042 (P Threepopnatkul et al. 2020). These values are compared with the experimental value for the polymer blend in accordance with this disclosure in Table 2 below.

TABLE 2
Comparison of WVTR Values to the Literature

| | | Average WVTR |
|---|---|---|
| | | (grams per square |
| Material | Polymer | meter per day) |
| Example 1 | PBAT/PLA/TPS | 275.95 +/− 27.01 |
| Comparative Material 1 | PBAT | 33.83 |
| Comparative Material 2 | PBATZ13X | 44.92 |
| Comparative Material 3 | PBATZ13X_K+ | 45.95 |
| Comparative Material 4 | Ingeo ™ 4060D | 206 +/− 13 |
| Comparative Material 5 | Ingeo ™ 4042D, quenched | 205 |
| Comparative Material 6 | Ingeo ™ 4042D, slow | 204 +/− 10 |
| | cooled | |
| Comparative Material 7 | Ingeo ™ 4032D, quenched | 186 +/− 13 |
| Comparative Material 8 | Ingeo ™ 4032D, slow | 82 +/− 18 |
| | cooled | |
| Comparative Material 9 | Ingeo ™ 4032D, annealed | 162 +/− 12 |
| | at 130° C. for 5 minutes | |
| Comparative Material 10 | Ingeo ™ 4032D, annealed | 141 +/− 8 |
| | at 100° C. for 18 minutes | |
| Comparative Material 11 | Ingeo ™ 4032D, annealed | 91 +/− 4 |
| | at 115° C. for 25 minutes | |

In Table 2 above, PBATZ13X denotes polybutylene adipate terephthalate blended with Zeolite 13X molecular sieves. PBATZ13X_K+ denotes polybutylene adipate terephthalate blended with Zeolite 13X molecular sieves treated by doping with potassium ions. Ingeo™ 4060D, Ingeo™ 4042D, and Ingeo™ 4032D are different grades of polylactic acid commercially available from NatureWorks LLC under the trade name Ingeo™.

The values in Table 2 show that a blend of PBAT, PLA, and TPS has a higher WVTR than various known types of PLA and PBAT on their own.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A biodegradable and non-fibrous film comprising:
a thermoplastic polysaccharide; and
a biodegradable polyester;
wherein the film has a thickness of from about 15 μm to about 250 μm;
wherein when the film has a thickness of 50 μm, the film has a water vapor transmission rate of from about 50 grams per square meter per day to about 2500 grams per square meter per day, as measured in accordance with ASTM E96-22 at a temperature of 38° C., a relative humidity of 90%, an airflow velocity of 0.3 m/s, and a barometric pressure of 941.2 mbar.

2. The biodegradable and non-fibrous film of claim 1, wherein the water vapor transmission rate of the film varies by from about 0.1 grams per square meter per day to about 100 grams per square meter per day, across a sample of the film having a surface area of 50 square centimeters, as measured in accordance with ASTM E96-22 at a temperature of 38° C., a relative humidity of 90%, an airflow velocity of 0.3 m/s, and a barometric pressure of 941.2 mbar.

3. The biodegradable and non-fibrous film of claim 1, wherein the biodegradable polyester is selected from polylactic acid, polybutylene adipate terephthalate, polycaprolactone, polyhydroxybutyrate, poly(3-hydroxybutyrate-co-3-hydroxyhexanoate, poly(3-hydroxybutyrate-co-3-hydroxyvalerate), polybutylene succinate, polysulfone, or combinations thereof.

4. The biodegradable and non-fibrous film of claim 1, wherein the film is a single layer having a uniform composition.

5. The biodegradable and non-fibrous film of claim 1, wherein the thermoplastic polysaccharide is formed from a polysaccharide selected from a starch, carrageenan, cellulose, viscose, glycogen, chitin, hemicellulose, or combinations thereof.

6. The biodegradable and non-fibrous film of claim 1, wherein the thermoplastic polysaccharide is present in an amount of from about 40 wt % to about 50 wt %, based on a total weight of the film.

7. The biodegradable and non-fibrous film of claim 1, further comprising a polymer-degrading enzyme.

8. The biodegradable and non-fibrous film of claim 1, further comprising a plasticizer.

9. The biodegradable and non-fibrous film of claim 1, formed through a gel extrusion process.

10. The biodegradable and non-fibrous film of claim 1, wherein the film is further characterized as non-porous.

11. A biodegradable package having an inner surface that defines a void, wherein the package is formed from the biodegradable and non-fibrous film of claim 1.

12. The biodegradable package of claim 11, free of any additional layer different from the film laminated thereto.

13. The biodegradable package of claim 11, free of a woven or non-woven porous material.

14. The biodegradable package of claim 11, further comprising an active material retained by opposing layers of the film.

15. The biodegradable package of claim 13, wherein the opposing layers of the film are sealed to each other about a perimeter thereof to define a sealed void.

16. A method of forming a biodegradable and non-fibrous film, the method comprising the steps of:
blending a thermoplastic polysaccharide and a biodegradable polyester to form an intermediate composition; and
gel extruding the intermediate composition to form a film;
wherein the film has a thickness of from about 15 μm to about 250 μm;
wherein when the film has a thickness of 50 μm, the film has a water vapor transmission rate of from about 50 grams per square meter per day to about 2500 grams per square meter per day, as measured in accordance with ASTM E96-22 at a temperature of 38° C., a relative humidity of 90%, an airflow velocity of 0.3 m/s, and a barometric pressure of 941.2 mbar.

17. The method of claim 16, further comprising forming the film into a package having an inner surface that defines a void.

18. The method of claim 16, further comprising sealing opposing layers of the film to each other about a perimeter thereof to define a sealed void.

19. The method of claim 16, wherein a polymer-degrading enzyme and a plasticizer are blended with the thermoplastic polysaccharide and the biodegradable polyester.

20. The method of claim 16, wherein the method is free of laminating any additional layer different from the film thereto.
